(19) United States
(12) Patent Application Publication
(10) Pub. No.: US 2018/0046295 A1
(43) Pub. Date: Feb. 15, 2018

(54) TOUCH DISPLAY DEVICE

(71) Applicant: HON HAI PRECISION INDUSTRY CO., LTD., New Taipei (TW)

(72) Inventors: YU-FU WENG, New Taipei (TW); CHIA-LIN LIU, New Taipei (TW); CHIEN-WEN LIN, New Taipei (TW); TZU-YU CHENG, New Taipei (TW)

(21) Appl. No.: 15/671,143

(22) Filed: Aug. 8, 2017

Related U.S. Application Data
(60) Provisional application No. 62/374,107, filed on Aug. 12, 2016.

(51) Int. Cl. G06F 3/041; G02F 1/1343; G02F 1/1335; G06F 3/044; G02F 1/1333; G02F 1/1368

(52) U.S. Cl. CPC G06F 3/0412; G02F 1/13338; G02F 1/1368; G02F 1/133514; G06F 3/044; G02F 1/134336; G02F 1/133308; G06F 3/0416; G06F 2203/04112

(57) ABSTRACT

A touch display device able to receive touches and sense the touch forces includes a color filter substrate, a thin film transistor substrate, a liquid crystal layer, and an electrically-conductive frame on a side of the display panel away from the color filter substrate. First electrodes are formed on a surface of the color filter substrate adjacent to the liquid crystal layer and second electrodes are formed on a surface of a thin film transistor substrate adjacent to the liquid crystal layer. The first electrodes and the second electrodes cooperatively form a first capacitor for sensing touch force, and the second electrodes and the electrically-conductive frame cooperatively form a second capacitor for sensing touch force.

### FIELD

The subject matter herein generally relates to a touch display device.

### BACKGROUND

An on-cell or in-cell type touch screen device can be manufactured by installing a touch device in a touch display device. Such a touch screen device can be used as an output device for displaying images while being used as an input device for receiving a touch of a user touching a specific area of a displayed image. However, the touch screen device cannot sense the amount of touch force/pressure applied to the touch screen.

### BRIEF DESCRIPTION OF THE DRAWINGS

Implementations of the present disclosure will now be described, by way of example only, with reference to the attached figures.

FIG. 1 is a planar view of an exemplary embodiment of a touch display device.

FIG. 2 is a cross-sectional view of a first exemplary embodiment of the touch display device of FIG. 1 along line II-II.

FIG. 3 is a planar view showing a layout of second electrodes of the touch display device of FIG. 1.

FIG. 4 is a planar view showing a layout of the first exemplary embodiment of first electrodes of the touch display device of FIG. 1.

FIG. 5 is a planar view showing a layout of the second exemplary embodiment of the first electrodes of the touch display device of FIG. 1.

FIG. 6 is a cross-sectional view of the touch display device of FIG. 2 when being touched by a first touch force.

FIG. 7 is a cross-sectional view of the touch display device of FIG. 2 when being touched by a second touch force.

FIG. 8 shows a relationship between a second capacitance and a touch force applied on the touch display device of FIG. 2.

FIG. 9 shows a relationship between a first capacitance and a touch force applied on the touch display device of FIG. 2.

FIG. 10 shows a relationship between a total of the first capacitance and the second capacitance and a touch force applied on the touch display device of FIG. 2.

FIGS. 11 through 13 are diagrammatic views of three types of driving time sequence of the touch display device.

FIG. 14 is a cross-sectional view of a second exemplary embodiment of the touch display device of FIG. 1 along line II-II.

### DETAILED DESCRIPTION

It will be appreciated that for simplicity and clarity of illustration, where appropriate, reference numerals have been repeated among the different figures to indicate corresponding or analogous structures. In addition, numerous specific details are set forth in order to provide a thorough understanding of the exemplary embodiments described herein. However, it will be understood by those of ordinary skill in the art that the exemplary embodiments described herein may be practiced without these specific details. In other instances, methods, procedures, and components have not been described in detail so as not to obscure the related relevant feature being described. Also, the description is not to be considered as limiting the scope of the exemplary embodiments described herein. The drawings are not necessarily to scale and the proportions of certain parts may be exaggerated to better illustrate details and features of the present disclosure.

The term “coupled” is defined as connected, whether directly or indirectly through intervening components, and is not necessarily limited to physical connections. The connection can be such that the objects are permanently connected or releasably connected. The term “comprising” when utilized, means “including, but not necessarily limited to”; it specifically indicates open-ended inclusion or membership in the so-described combination, group, series, and the like.

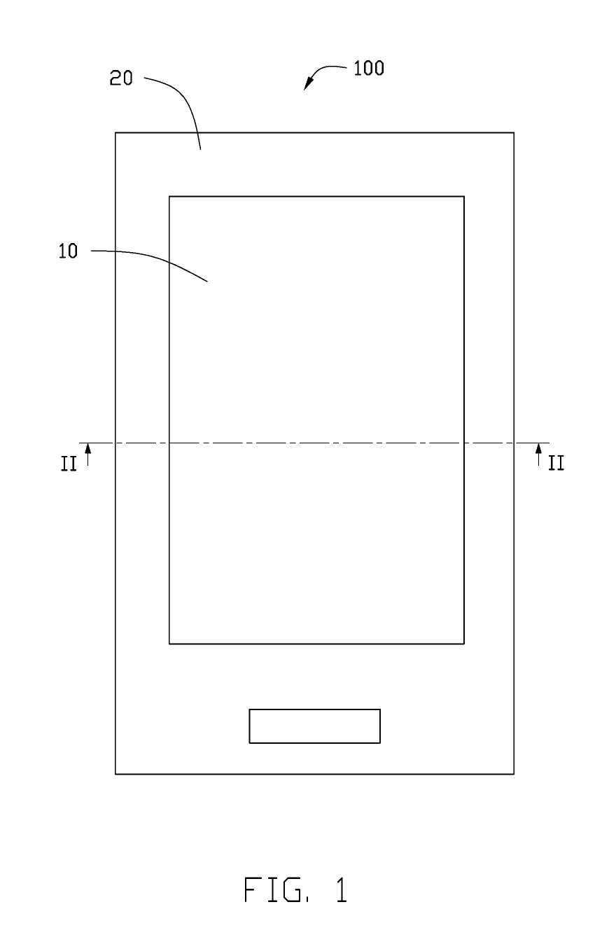

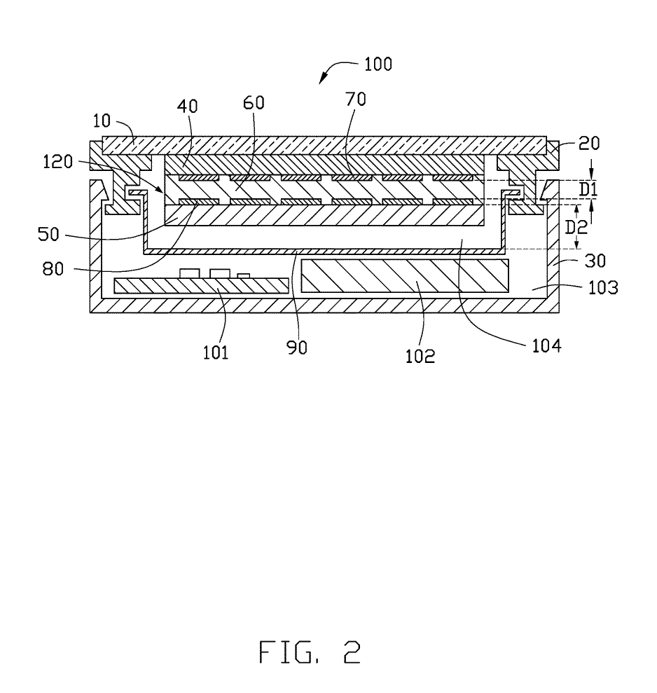

FIG. 1 and FIG. 2 illustrate a touch display device 100 according to a first exemplary embodiment. The touch display device 100 includes a cover plate 10, a housing 30, and a bonding frame 20 between the cover plate 10 and the housing 30. The housing 30 defines a receiving space 103 to receive other components of the touch display device 100. The cover plate 10 covers the receiving space 103. The cover plate 10 is transparent and can receive touches from objects (e.g., fingers and styluses). The bonding frame 20 is configured to couple the cover plate 10 and the housing 30 together. In this exemplary embodiment, the bonding frame 20 is located at a peripheral portion of the cover plate 10 and surrounds the cover plate 10. The housing 30 may be made of metal or plastic.

As shown in FIG. 2, the touch display device 100 further includes a display panel 120 in the receiving space 103. The display panel 120 includes a first substrate 40, a second substrate 50 facing the first substrate 40, and a liquid crystal layer 60 between the first substrate 40 and the second substrate 50 in the receiving space 103. The first substrate 40, the liquid crystal layer 60, and the second substrate 50 are stacked below the cover plate 10, where the first substrate 40 is adjacent to the cover plate 10. The first substrate 40 is a color filter substrate comprising a substrate (not explicitly shown) and a color filter layer (not explicitly shown) on the substrate; and the second substrate 50 is a thin film transistor substrate and includes a substrate (not explicitly shown) and a plurality of thin film transistors (not explicitly shown) on the substrate. A plurality of first electrodes 70 are formed on a surface of the first substrate 40 adjacent to the liquid crystal layer 60, and a plurality of second electrodes 80 are formed on a surface of the second substrate 50 adjacent to the liquid crystal layer 60.

As shown in FIG. 2, the touch display device 100 further includes an electrically-conductive frame 90 in the receiving space 103. The electrically-conductive frame 90 is at a side of the display panel 120 away from the first substrate 40. An air gap 104 is formed between the second substrate 50 and the electrically-conductive frame 90. In other embodiments, there may be no air gap and an elastic layer (not explicitly shown) may be installed between the second substrate 50 and the electrically-conductive frame 90. It is understood that the display panel 120 further includes a backlight module (not explicitly shown) between the second substrate 50 and the electrically-conductive frame 90. A distance between the second electrodes 80 and the electrically-conductive frame 90 is greater than a thickness of the second substrate 50.

The first electrodes 70 and the second electrodes 80 cooperatively form a first capacitor for sensing touch force, and the second electrodes 80 and the electrically-conductive frame 90 cooperatively form a second capacitor for sensing touch force. The intensity of the touch force can be calculated by variations of capacitances of the first capacitor and the second capacitor.

The touch display device 100 further includes a main board 101 and a battery 102 in the receiving space 103. Both the main board 101 and the battery 102 are between the electrically-conductive frame 90 and the housing 30. The main board 101 may have a plurality of components, such as an image processor, and the main board 101 may control many functions of the touch display device 100. The battery 102 supplies power to the touch display device 100.

In the present exemplary embodiment, the second electrodes 80 also function as common electrodes of The touch display device 100 and cooperate with pixel electrodes (not explicitly shown) to form electrical fields to rotate the liquid crystals in the liquid crystal layer 60. The second electrodes 80 also function as self-capacitance touch sensing electrodes for detecting touch position of the touch display device 100. When an object (e.g., a finger) is touching on the cover plate 10, the object as a conductor may affect electrical signals of the second electrodes 80 corresponding to the touch position, thus the touch position can be detected.

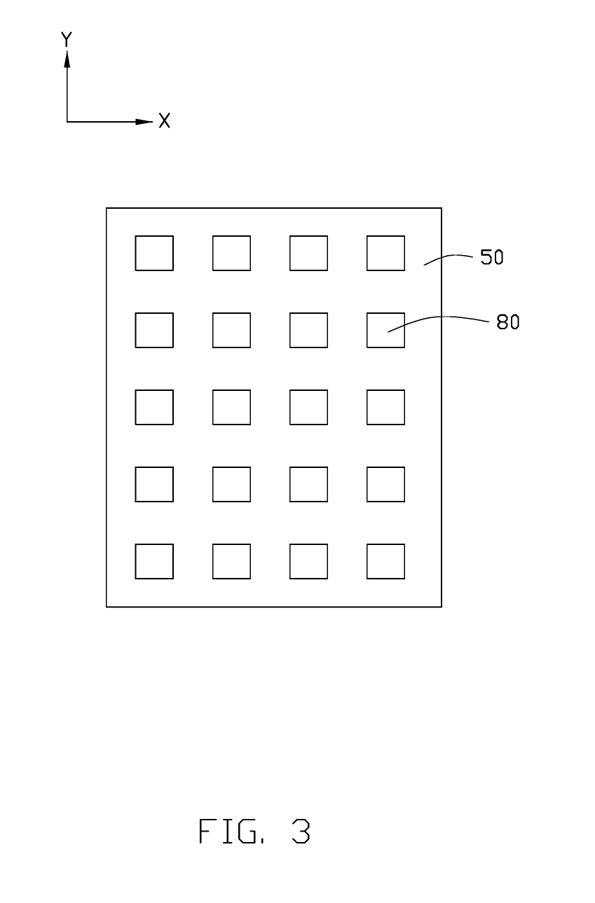

As shown in FIG. 3, the second electrodes 80 are spaced apart from each other and arranged in an array of rows and columns. In the present exemplary embodiment, each second electrode 80 is rectangular. In other embodiments, each second electrode 80 may have other shapes, such as round. Each second electrode 80 is electrically coupled to a driving circuit (not explicitly shown) of the touch display device 100 by conductive lines (not explicitly shown). In the present exemplary embodiment, the driving circuit of the touch display device 100 may be integrated with a touch sensing driver, a touch force sensing driver, and a display driver. In other embodiments, the driving circuit is only a touch sensing driver and a touch force sensing driver; and the display function of the touch display device is driven by an additional display driving circuit.

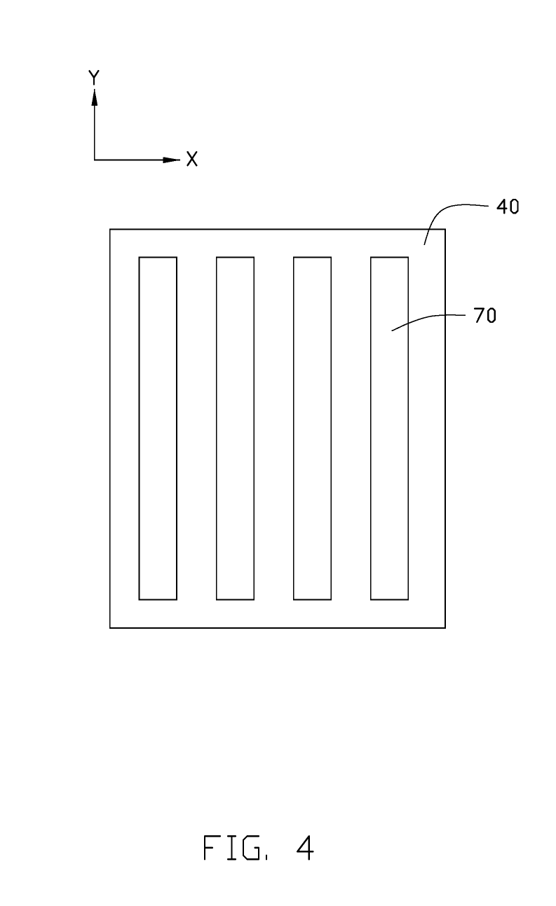

As shown in FIG. 4, the first electrodes 70 are spaced apart from each other. Each first electrode 70 extends as a strip along a direction of Y axis in FIG. 4. The first electrodes 70 are arranged in one row along a direction of X axis of FIG. 4. In the present exemplary embodiment, each first electrode 70 corresponds to one column of the second electrodes 80 along direction of Y axis of FIG. 3. Each first electrode 70 may be electrically coupled to the driving circuit (not explicitly shown) by conductive lines (not explicitly shown).

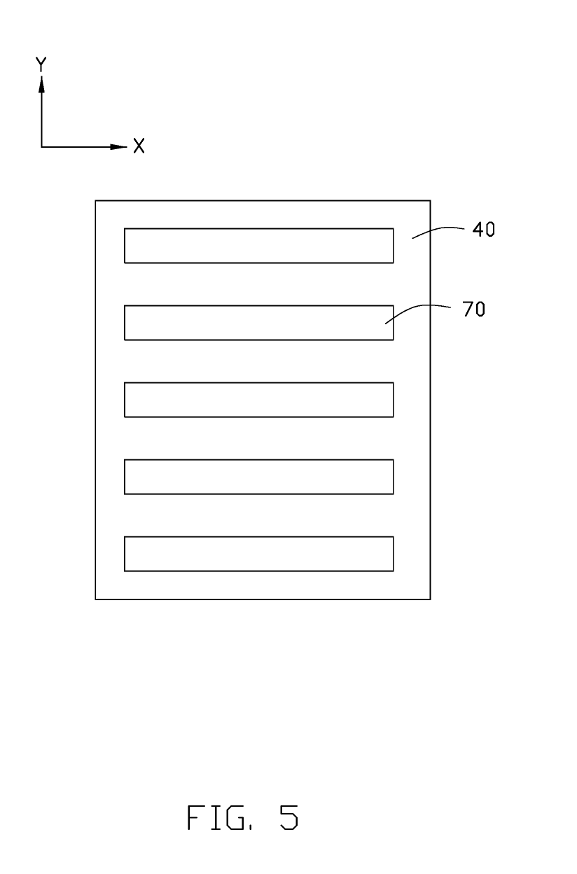

As shown in FIG. 5, in other embodiments, each first electrode 70 extends as a strip along a direction of X axis in FIG. 5. The first electrodes 70 are arranged in one column along a direction of Y axis of FIG. 5. In the present exemplary embodiment, each first electrode 70 corresponds to one row of the second electrodes 80 along a direction of X axis of FIG. 3.

It is understood that a distance between every two adjacent first electrodes 70 is sufficiently large such that electrical signals generated by a conductor (e.g., a finger of a user) touching on the cover plate 10 can be transmitted to the second electrode 80 below the first electrodes 70, and can affect electrical signals of the second electrode 80 so that the touch position can be sensed.

Both the first electrodes 70 and the second electrodes 80 may be made of a transparent conductive material, such as indium tin oxide (ITO). The first electrodes 70 and the second electrodes 80 can alternatively be arranged in a metal mesh pattern.

The electrically-conductive frame 90 may be made of an electrically-conductive metal or an electrically-conductive alloy, such as copper (Cu), silver (Ag), molybdenum (Mo), titanium (Ti), aluminum (Al), or tungsten (W). The electrically-conductive frame 90 may be grounded, to avoid the main board 101 and the battery 102 interfering with the display signals and the sensing signals of the touch display device 100.

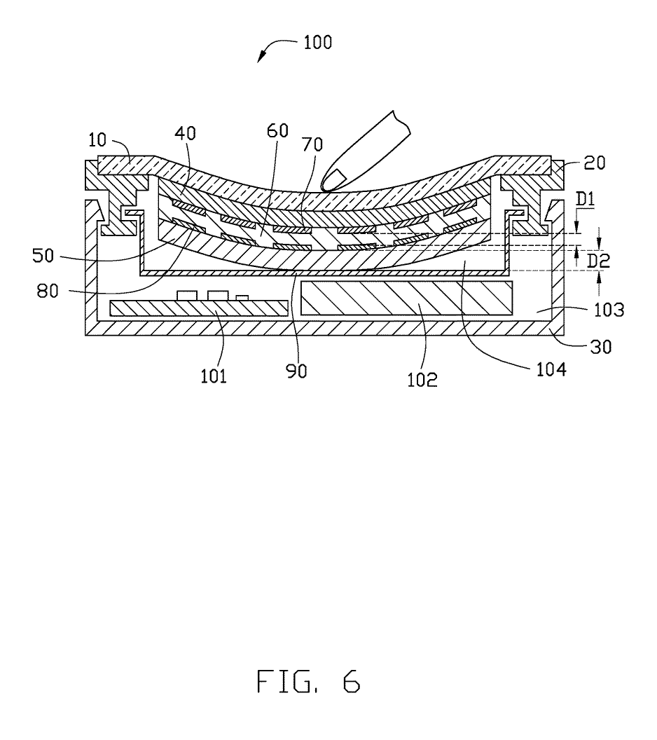

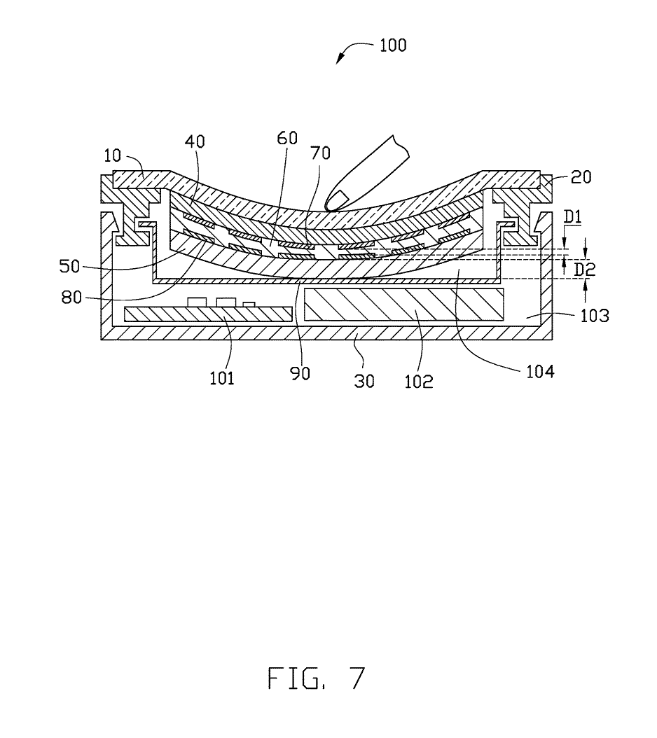

FIG. 6 is a cross-sectional view of the touch display device 100 when touched by a touch force equal to a first predetermined value a. FIG. 7 is a cross-sectional view of the touch display device 100 when touched by a touch force of greater the first predetermined value a. In the present exemplary embodiment, a distance between the first electrode 70 and the second electrode 80 is defined as a first distance D1, and a distance between the second electrode 80 and the electrically-conductive frame 90 is defined as a second distance D2. The first distance D1 is in a range from about 2 μm to about 4 μm. The second distance D2 is in a range from about 50 μm to about 300 μm. For example, an approximate formula for capacitance can be expressed as:

C=εS/4πkD (Eq. 1)

where C is a capacitance of a capacitor, S is an area of the overlapping region, D is a depth of a insulating layer, ε is a dielectric constant of the insulating layer, and k is an electrostatic constant. When ε, S, π, and k are fixed, the distance D varies proportionally with the capacitance C. As shown in FIG. 6 and FIG. 7, when a finger is touching on the cover plate 10 of the touch display device 100, the first distance D1 and the second distance D2 both decrease, and a first capacitance C1 of the first capacitor between the first electrode 70 and the second electrode 80 may vary. A second capacitance C2 of the second capacitor between the second electrode 80 and the electrically-conductive frame 90 may vary. Thus, the intensity or amount of the touch force can be calculated according to the variation of the respective capacitances of the first capacitor and the second capacitor. The touch display device 100 can thereby sense touch forces over a wide range.

As shown in FIGS. 6 and 7, when the touch force is equal to or greater than the first predetermined value a, the display panel 120 may deform towards the electrically-conductive frame 90, and be in direct contact with the electrically-conductive frame 90. The second distance D2 may reach a minimum value and may no longer vary.

In the present exemplary embodiment, the relationship between the second capacitance C2 and the touch force X applied on the cover plate 10 is defined by:

C2=f(X) (Eq. 2)

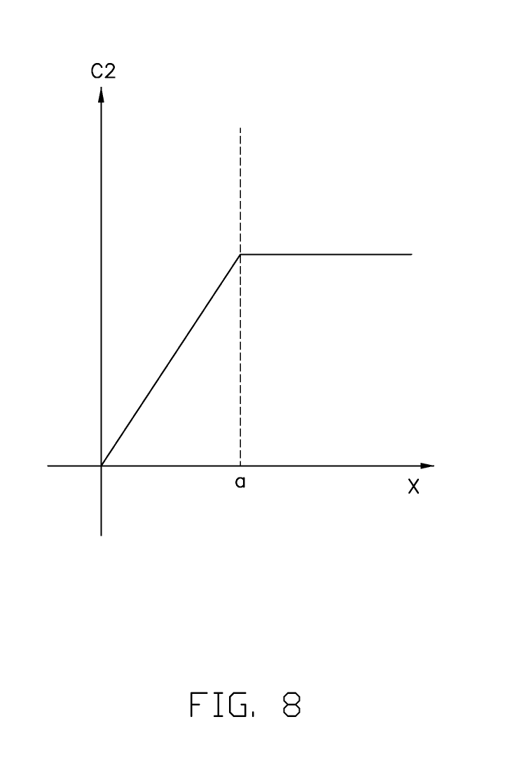

When the touch force X is less than the first predetermined value a, the greater the touch force X, the less the second distance D2 will be, and the greater the second capacitance C2 will be (as illustrated in FIG. 8). When the touch force X is not less than the first predetermined value a, the second distance D2 reaches the minimum and may no longer vary, thus the second capacitance C2 reaches a maximum value and may no longer vary.

In the present exemplary embodiment, the relationship between the first capacitance C1 and the touch force X applied on the cover plate 10 is defined by:

C1=g(X) (Eq. 3)

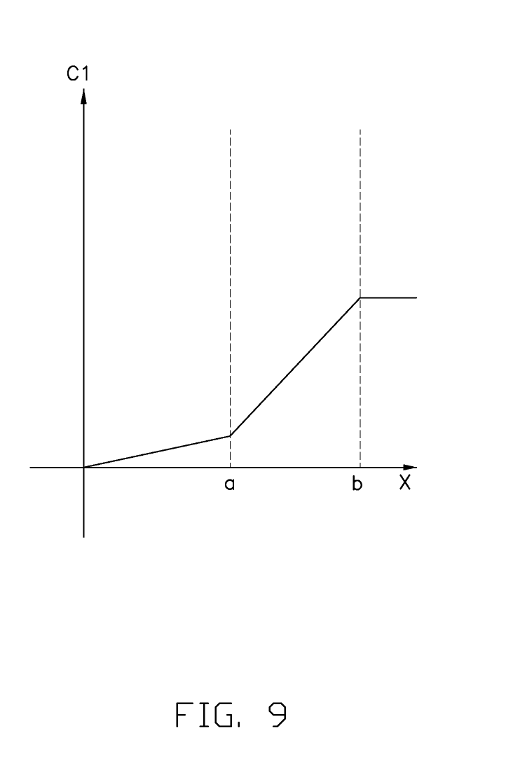

As shown in FIG. 9, when the touch force X is less than a second predetermined value b, the greater the touch force X, the less the first distance D1 will be, and the greater the first capacitance C1 will be. When the touch force X is not less than the second predetermined value b, the first distance D1 reaches a minimum value and may no longer vary. The first capacitance C1 reaches a maximum value and may no longer vary. In addition, when the touch force X applied to the cover plate 10 is greater than the first predetermined value a and less than the second predetermined value b, a variation in magnitude of the first capacitance C1 when increasing one unit of the touch force X is greater than that when the touch force X applied to the cover plate 10 is less than the first predetermined value a.

The first capacitance C1 and the second capacitance C2 are added together to be a total capacitance C. In the present exemplary embodiment, a relationship between the total capacitance C and the touch force X applied on the cover plate 10 may be defined by:

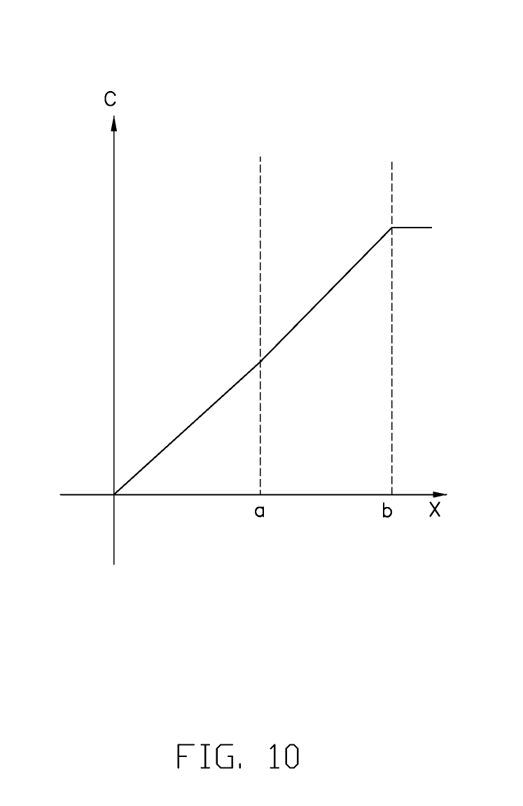

C=a*f(X)+b*g(X)+c (Eq. 4)

wherein a, b, and c are constants. The Equation (4) may be obtained by combining Equation (2) and Equation (3). As shown in FIG. 10, the total capacitance C increases linearly with the touch force X. When the touch force X is less than the second predetermined value b, the capacitance C increases. The total capacitance C reaches a maximum value and may no longer vary when the touch force X is not less than the second predetermined value b. Thus, the intensity of the touch force can be calculated according to the variation of the total capacitance C. It is understood that the relationship between the total capacitance C and the touch force X applied on the cover plate 10 is not limited to that suggested by FIG. 10.

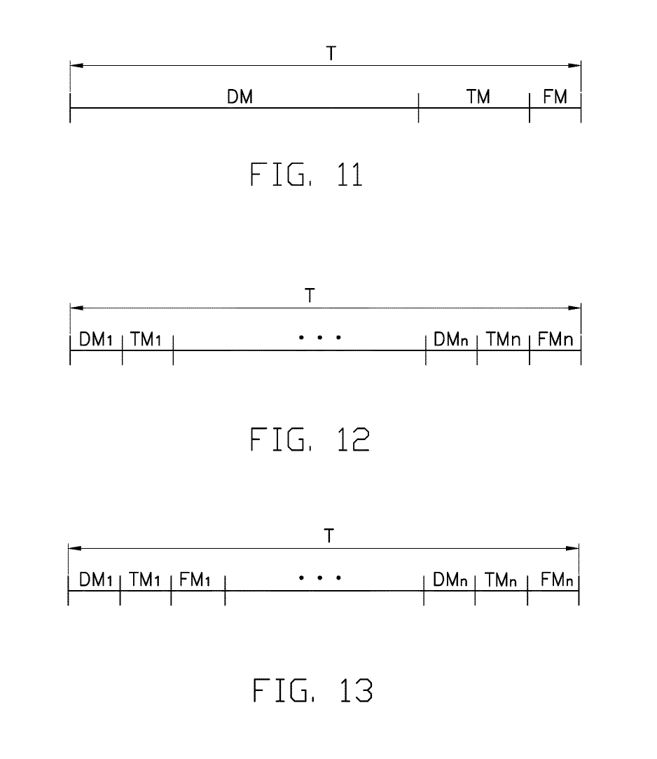

FIGS. 11, 12 and 13 show three different driving time sequences of the touch display device 100 of the first exemplary embodiment. The touch display device 100 is driven by a time division driving method.

As shown in FIG. 11, one frame of time, or a single frame, is divided into a display period (DM), a touch sensing period (TM), and a touch force sensing period (FM). The driving circuit of the touch display device alternately drives the touch display device 100 to display during the DM, to detect touch position during the TM, and to detect touch force during the FM in one frame time.

As shown in FIG. 12, one frame time, or a single frame, is divided into a plurality of display sub-periods (DM₁ through DMₙ), a plurality of touch sensing sub-periods (TM₁ through TMₙ), and a touch force sensing period (FM). The display sub-periods (DM₁ through DMₙ) and the touch sensing sub-periods (TM₁ through TMₙ) are alternating. The driving circuit of the touch display device alternately drives the touch display device to display during each display sub-period and to detect touch position during each touch sensing sub-period; and finally drives the touch display device to detect touch force during the FM, in one frame of time.

As shown in FIG. 13, one frame of time, or a single frame, is divided into a plurality of display sub-periods (DM₁ through DMₙ), a plurality of touch sensing sub-periods (TM₁ through TMₙ), and a plurality of touch force sensing sub-periods (FM₁ through FMₙ). The display sub-periods (DM₁ through DMₙ), the touch sensing sub-periods (TM₁ through TMₙ), and the touch force sensing sub-periods (FM₁ through FMₙ) are alternating. The driving circuit of the touch display device alternately drives the touch display device to display during each display sub-period, to detect touch position during each touch sensing sub-period, and to detect touch force during each touch force sensing sub-period in one frame of time.

During the display period or the display sub-periods, for the touch display device 100 of the first exemplary embodiment, each second electrode 80 may be applied with a common voltage, the electrically-conductive frame 90 may be electrically grounded, and each first electrode 70 may be floating or have a common voltage applied thereto.

During the touch sensing period or the touch sensing sub-period, for the touch display device 100 of the first exemplary embodiment, each second electrode 80 may be applied with a signal pulse voltage, the electrically-conductive frame 90 may be electrically grounded, and each first electrode 70 may be floating or have a common voltage applied thereto.

During the force sensing period or the force sensing sub-periods, for the touch display device 100 of the first exemplary embodiment, each second electrode 80 may be applied with a signal pulse voltage, the electrically-conductive frame 90 may be electrically grounded or receive a signal pulse voltage, and each first electrode 70 may be floating or may receive a signal pulse voltage.

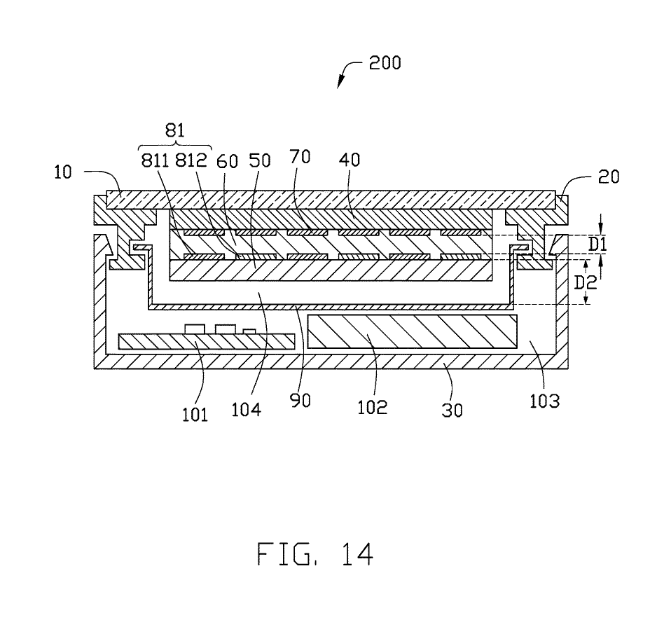

FIG. 14 illustrates a touch display device 200 according to a second exemplary embodiment. The touch display device 200 is substantially the same as the touch display device 100 of the first exemplary embodiment, except that the second electrodes 80 are divided into a plurality of first sub-electrodes 811 and a plurality of second sub-electrodes 812. The first sub-electrodes 811 and the first electrodes 70 cooperatively form a first capacitor for sensing touch force and the first sub-electrodes 811 and the electrically-conductive frame 90 cooperatively form a second capacitor for sensing touch force. The second sub-electrodes 812 function as electrodes of the touch display device 200 for detecting touch position. The first sub-electrodes 811 and the second sub-electrodes 812 also function as common electrodes of the touch display device 100 and cooperate with pixel electrodes (not explicitly shown) to form electrical fields to rotate the liquid crystals in the liquid crystal layer 60.

Each first sub-electrode 811 and each first electrode 70 are spaced apart from each other. The shape and arrangement of the first sub-electrode 811 and the second sub-electrode 812 are not limited.

The touch display device 200 is also driven by a time division driving method. The three different driving time sequences shown in FIG. 11 through FIG. 13 may also suitable for the touch display device 200 of the second exemplary embodiment.

During the display period or the display sub-periods, for the touch display device 200 of the second exemplary embodiment, each first sub-electrode 811 and each second sub-electrode 812 may receive a common voltage and the electrically-conductive frame 90 may be electrically grounded. Each first electrode 70 may be floating or may receive a common voltage.

During the touch sensing period or the touch sensing sub-period, for the touch display device 200 of the second exemplary embodiment, each first sub-electrode 811 may receive a common voltage. Each second sub-electrode 812 may be applied with a signal pulse voltage and the electrically-conductive frame 90 may be electrically grounded. Each first electrode 70 may be floating or may receive a common voltage.

During the force sensing period or the force sensing sub-periods, for the touch display device 200 of the second exemplary embodiment, each first sub-electrode 811 may receive a signal pulse voltage. Each second electrode 80 may receive a common voltage or be electrically grounded. The electrically-conductive frame 90 may be electrically grounded or it may receive a signal pulse voltage, and each first electrode 70 may be floating or receive a signal pulse voltage.

In one exemplary embodiment, it is desirable that each first electrode 70 receives a common voltage during the DM and the TM. Each first electrode 70 and each second electrode 80 receive a common voltage during the DM. Thus, the voltages of the touch display device during display periods are more stable, and the performance of the touch display device can be improved.

It is to be understood, even though information and advantages of the present exemplary embodiments have been set forth in the foregoing description, together with details of the structures and functions of the present exemplary embodiments, the disclosure is illustrative only. Changes may be made in detail, especially in matters of shape, size, and arrangement of parts within the principles of the present exemplary embodiments to the full extent indicated by the plain meaning of the terms in which the appended claims are expressed.

What is claimed is:

1. A touch display device comprising:
a color filter substrate;
a thin film transistor substrate facing the color filter substrate;
a liquid crystal layer between the color filter substrate and the thin film transistor substrate; and
an electrically-conductive frame on a side of the thin film transistor substrate away from the color filter substrate;
wherein a plurality of first electrodes are formed on a surface of the color filter substrate adjacent to the liquid crystal layer; a plurality of second electrodes are formed on a surface of the thin film transistor substrate adjacent to the liquid crystal layer; the plurality of first electrodes and the plurality of second electrodes cooperatively form a first capacitor for sensing a touch force, and the plurality of second electrodes and the electrically-conductive frame cooperatively form a second capacitor for sensing the touch force; the plurality of second electrodes functions as electrodes of the touch display device for sensing a touch position.

2. The touch display device of claim 1, wherein an air gap is formed between the thin film transistor substrate and the electrically-conductive frame.

3. The touch display device of claim 1, wherein a first distance is formed between the plurality of first electrodes and the plurality of second electrodes; a second distance is formed between the plurality of second electrodes and the electrically-conductive frame; and the first capacitor has a first capacitance C1; the second capacitor has a second capacitance C2; the second capacitance C2 increases to be a maximum and keep at the maximum when a touch force on the touch display device is no less than a predetermined value.

4. The touch display device of claim 3, wherein an intensity of the touch force is calculated according to a variation of the total capacitance C of the first capacitance C1 and the second capacitance C2.

5. The touch display device of claim 1, wherein the plurality of second electrodes also functions as common electrodes of the touch display device.

6. The touch display device of claim 1, wherein the electrically-conductive frame is made of an electrically-conductive metal or an electrically-conductive alloy.

7. The touch display device of claim 1, wherein the plurality of second electrodes are spaced apart from each other and arranged in an array of rows and columns.

8. The touch display device of claim 7, wherein the plurality of first electrodes are spaced apart from each other; each of the plurality of first electrodes extends as a strip along a direction.

9. The touch display device of claim 1, wherein each of the plurality of first electrodes corresponds to one row of the second electrodes or one column of the second electrodes.

10. The touch display device of claim 1, wherein the plurality of second electrodes are divided into a plurality of first sub-electrodes and a plurality of second sub-electrodes; the plurality of first sub-electrodes and the plurality of first electrodes cooperatively form the first capacitor; the plurality of first sub-electrodes and the electrically-conductive frame cooperatively form the second capacitor; and the plurality of second sub-electrodes function as electrodes of the touch display device for sensing the touch position.

11. The touch display device of claim 10, wherein the plurality of first sub-electrodes and the plurality of second sub-electrodes also function as common electrodes of the touch display device.

12. The touch display device of claim 1, wherein the touch display device is driven by a time division method.
